(19) United States
(12) Patent Application Publication
(10) Pub. No.: US 2025/0140069 A1
(43) Pub. Date: May 1, 2025

(54) ELECTRONIC GAME FOR RECREATING OUTCOMES USING DIFFERENT FEATURES

(71) Applicant: Aristocrat Technologies, Inc., Las Vegas, NV (US)

(72) Inventors: David Marsh, Charlottesville, VA (US); Zachary Cooper, Reno, NV (US)

(21) Appl. No.: 18/590,544

(22) Filed: Feb. 28, 2024

Related U.S. Application Data
(60) Provisional application No. 63/594,336, filed on Oct. 30, 2023.

(51) Int. Cl. G07F 17/32

(52) U.S. Cl. CPC G07F 17/3267; G07F 17/3213; G07F 17/329

(57) ABSTRACT

An electronic gaming system includes a processor and a memory storing instructions, which when executed by the processor, cause the processor to generate an output in response to a player input at a gaming device; evaluate the output to determine an award value; select, based on the award value, a presentation record of an electronic game that includes a base game mode and a feature game mode from a plurality of presentation records stored in the memory, wherein the plurality of presentation records includes: a first presentation record set including presentation records each including a base game mode outcome without a feature; a second presentation record set including presentation records each including a feature of the base game mode; and a third presentation record set including presentation records each including a feature of the feature game mode; and cause display of the selected presentation record on the display device.

### CROSS-REFERENCE TO RELATED APPLICATION(S)

This application claims priority to U.S. Provisional Patent Application No. 63/594,336, filed Oct. 30, 2023, the disclosure of which is hereby incorporated herein by reference in its entirety.

### TECHNICAL FIELD

The field of disclosure relates generally to electronic gaming, and more particularly, to systems and methods for providing an electronic game that recreates primary game awards and includes multiple features for presenting different tiers of primary game awards.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is provided. The electronic gaming system includes a display device configured to display an electronic game that includes a base game mode and a feature game mode, a processor, and a memory storing instructions, which when executed by the processor, cause the processor to: generate an output in response to a player input at a gaming device; evaluate the output to determine an award value; select, based on the award value, a presentation record of the electronic game from a plurality of presentation records stored in the memory, wherein the plurality of presentation records includes: a first presentation record set including presentation records each including an outcome of the base game mode without a feature; a second presentation record set including presentation records each including a feature of the base game mode; and a third presentation record set including presentation records each including a feature of the feature game mode; wherein the first presentation record set is associated with a first range of award values, the second presentation record set is associated with a second range of award values different from the first range, and the third presentation record set is associated with a third range of award values different from the first range and the second range; and cause display of the selected presentation record on the display device. The instructions may direct additional, less, or other functionality, including that which is described herein.

In another aspect, a non-transitory computer-readable medium containing instructions stored thereon is provided. The instructions, when executed by a processor, cause the processor to: control a display device to display an electronic game that includes a base game mode and a feature game mode; generate an output in response to a player input at a gaming device; evaluate the output to determine an award value; select, based on the award value, a presentation record of the electronic game from a plurality of presentation records stored in a memory, wherein the plurality of presentation records includes: a first presentation record set including presentation records each including an outcome of the base game mode without a feature; a second presentation record set including presentation records each including a feature of the base game mode; and a third presentation record set including presentation records each including a feature of the feature game mode; wherein the first presentation record set is associated with a first range of award values, the second presentation record set is associated with a second range of award values different from the first range, and the third presentation record set is associated with a third range of award values different from the first range and the second range; and control the display device to display the selected presentation record. The instructions may direct additional, less, or other functionality, including that which is described herein.

In yet another aspect, a computer-implemented method for providing an electronic game on an electronic gaming device is provided. The method includes: controlling a display device to display an electronic game that includes a base game mode and a feature game mode; generating an output in response to a player input at a gaming device; evaluating the output to determine an award value; selecting, based on the award value, a presentation record of the electronic game from a plurality of presentation records stored in a memory, wherein the plurality of presentation records includes: a first presentation record set including presentation records each including an outcome of the base game mode without a feature; a second presentation record set including presentation records each including a feature of the base game mode; and a third presentation record set including presentation records each including a feature of the feature game mode; wherein the first presentation record set is associated with a first range of award values, the second presentation record set is associated with a second range of award values different from the first range, and the third presentation record set is associated with a third range of award values different from the first range and the second range; and controlling the display device to display the selected presentation record. The method may include additional, less, or other actions, including that which is described herein.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a process flow diagram depicting an example method for providing an electronic game that may be implemented using an electronic gaming system.

FIG. 5 is a screen capture or user interface of the example electronic game provided by the method of FIG. 4 in a base game mode.

FIG. 6 is a screen capture or user interface of the example electronic game showing a base game mode feature.

FIG. 7 is a screen capture or user interface of the example electronic game showing a pick bonus game in a first feature game mode.

FIG. 8 is a screen capture or user interface of the example electronic game showing a wheel bonus game in the first feature game mode.

FIGS. 9-11 are screen captures or user interfaces of the example electronic game showing a sequence of a hold-and-spin game in a second feature game mode.

FIG. 12 is a screen capture or user interface of an alternative display of the hold-and-spin game shown in FIGS. 9-11.

Corresponding reference numerals used throughout the drawings indicate corresponding elements.

### DETAILED DESCRIPTION

In conventional electronic gaming systems and methods, awards and/or outcomes of a primary game may be recreated and presented to a player as awards and/or outcomes of a secondary game. For example, an electronic gaming device operating a pre-programed or Central Determination System (CDS) game (e.g., an e-ticket lottery game or a Class II bingo game) may present an outcome of the “primary” game as a reel game (e.g., a slot game) simulation. The outcome of the primary game is determinative of an outcome of the simulated reel game. For example, an award value associated with the primary game outcome may be presented in the simulated reel game outcome as a symbol combination and/or one or more special symbols that correspond to the same award value. The simulated reel game outcome used to recreate and present the primary game outcome may be determined based on a look-up operation using the award value of the primary game outcome.

Typically, the simulated reel game outcomes are stored in a database or memory. This may require a large amount of data storage and computational resources due to the number of possible primary game outcomes and simulated reel game outcomes for presenting the primary game outcomes. Additionally and/or alternatively, the number of possible ways to present a primary game outcome may be limited due to limited computational resources. A need exists to address these limitations to facilitate increasing the variability and flexibility in presenting recreated outcomes of primary games (e.g., pre-programed or CDS games) and reducing the computational resources used while doing so.

Various embodiments of the present disclosure are directed to presenting or recreating outcomes of an output of the gaming device using multiple different features of an electronic game simulation. The features may be displayed as part of a base game mode or a feature game mode of the game simulation. In example embodiments, presentation records are stored in a memory or database and each presentation record includes one or more of the features. The presentation records are associated with different outputs of the gaming device, for example, different outcomes of a primary game (e.g., an e-ticket lottery game or a Class II bingo game). The different presentation records associated with different features may be tiered such that the features are used for different award value ranges. For example, features played in the base game mode, may be used to recreate primary game outcomes with relatively lower award values, and features played in the feature game mode may be used to recreate primary game outcomes with relatively higher award values of the primary. This not only increases the flexibility and variability of the electronic game, but also facilitates reducing the amount of memory required for storing recreated outcomes as well as the computational resources required to recreate the primary game outcomes with the simulated reel game. For example, because the different features can be used to recreate different award values based on their respective amount, the number of outcomes that need to be stored in memory for recreating primary game outcomes may be reduced.

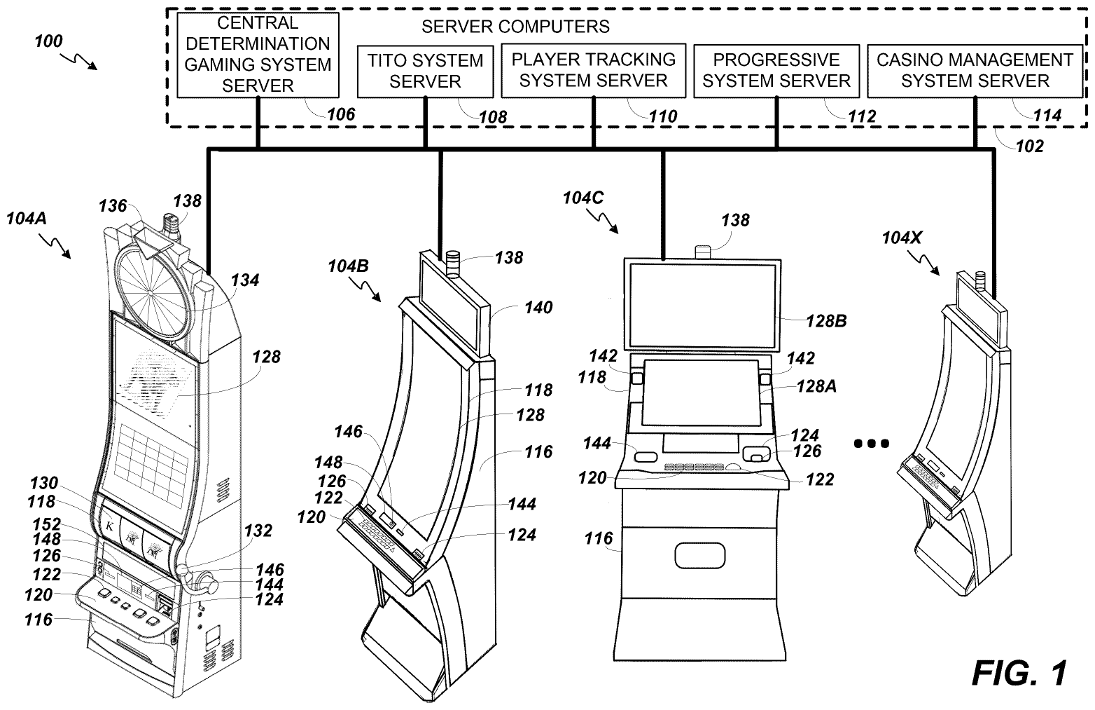

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

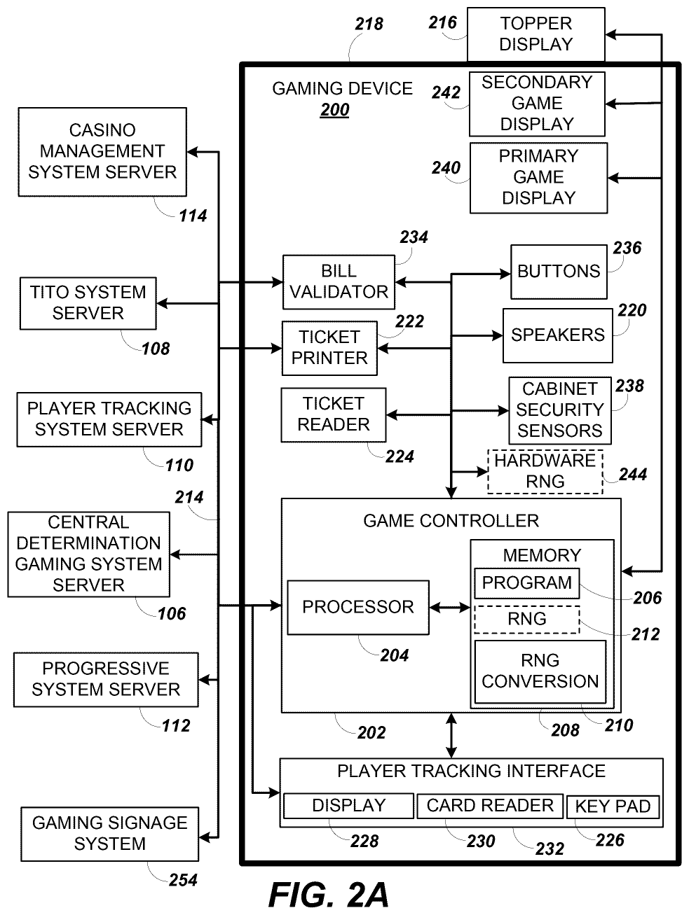

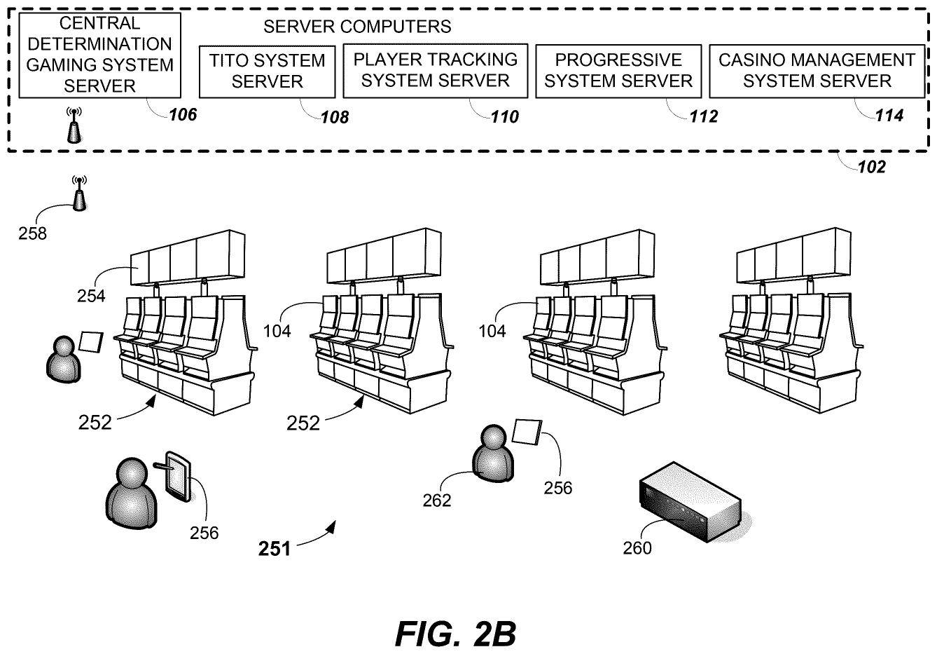

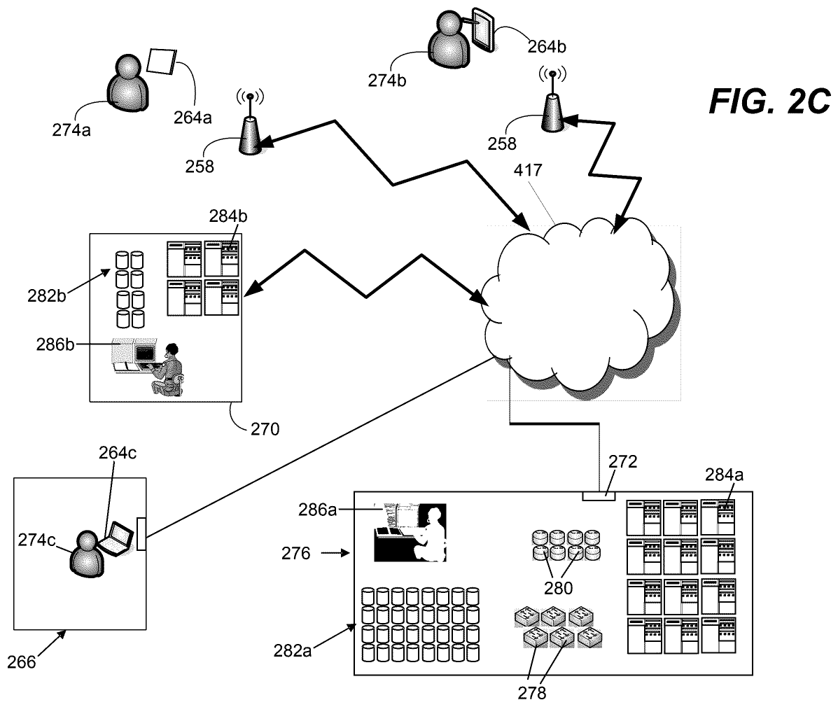

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

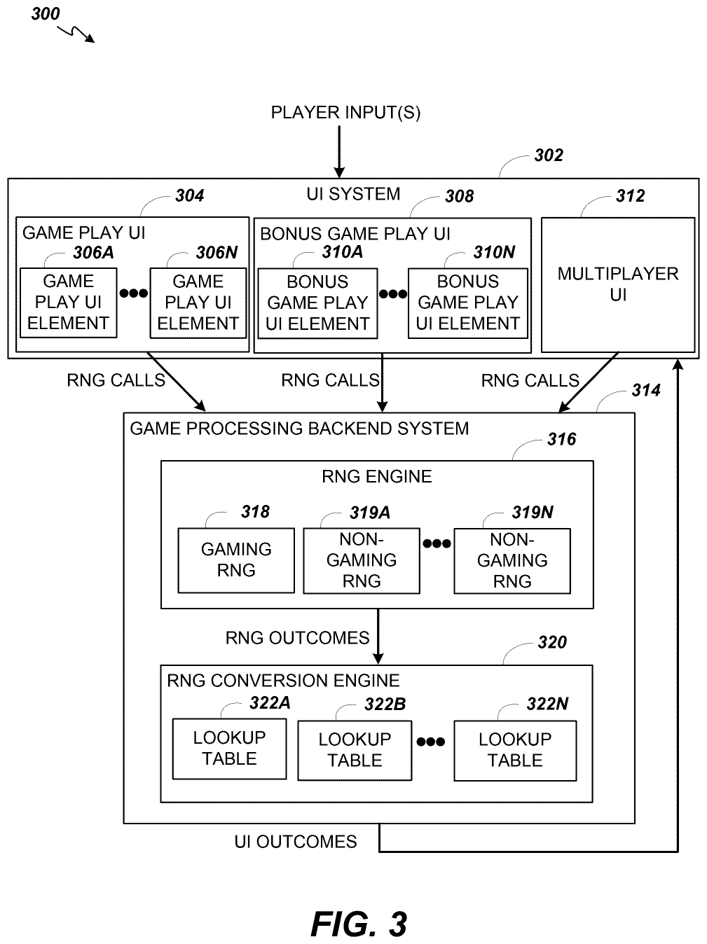

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

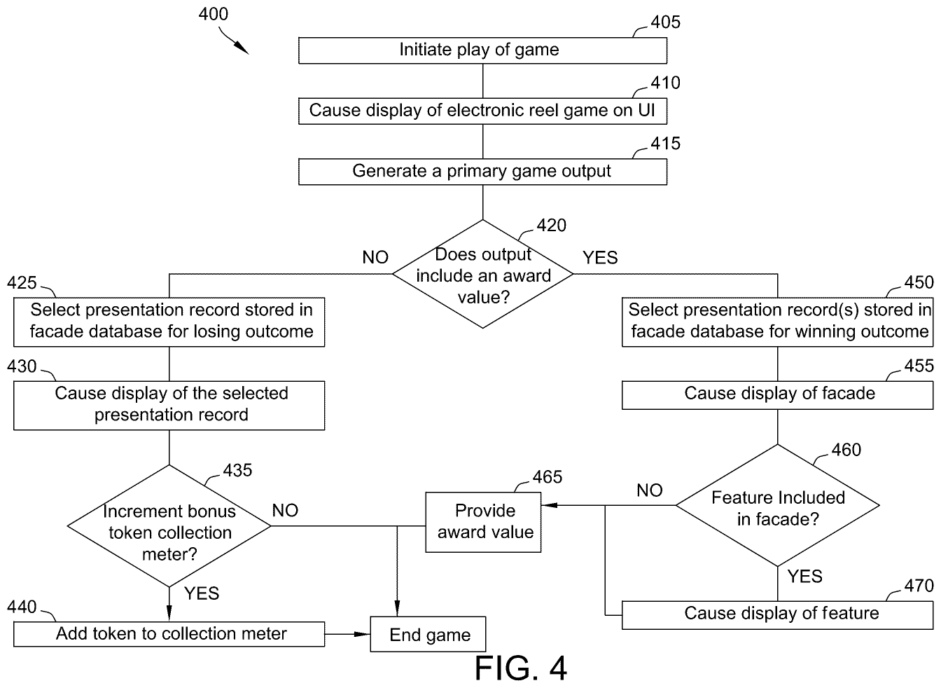

FIG. 4 is a flow chart of an exemplary process 400 for executing electronic game play for display to a user. The process 400 may be implemented in a server (e.g., server 106) and/or a gaming device (e.g., gaming devices 104A-104X in FIG. 1, and/or gaming device 200 and/or mobile gaming device 256 and/or EUD 264a-264c in FIG. 2). For example, in an electronic gaming device, a game controller (e.g., game controller 202) includes one or more processors 204 operatively coupled to memory 208. The memory 208 can store one or more game programs 206 that provide program instructions and/or data for carrying out various implementations (e.g., game mechanics) that, when executed by the processor 204, cause the processor 204 to perform certain operations to perform the process 400. Description of the operations of the process 400 being performed by the processor 204 includes implementations where multiple processors 204 are utilized. Moreover, some of the operations of the process 400 may be performed at the gaming device while some of the operations of the process may be performed at the server 106.

At operation 405, the processor 204 initiates a play instance of a game. In some embodiments, prior to initiating the play instance, the processor 204 first receives a selection of a bet option from the player, for example, via buttons 236. In an example, there are a plurality of bet options where bet1<bet2<bet3 etc.

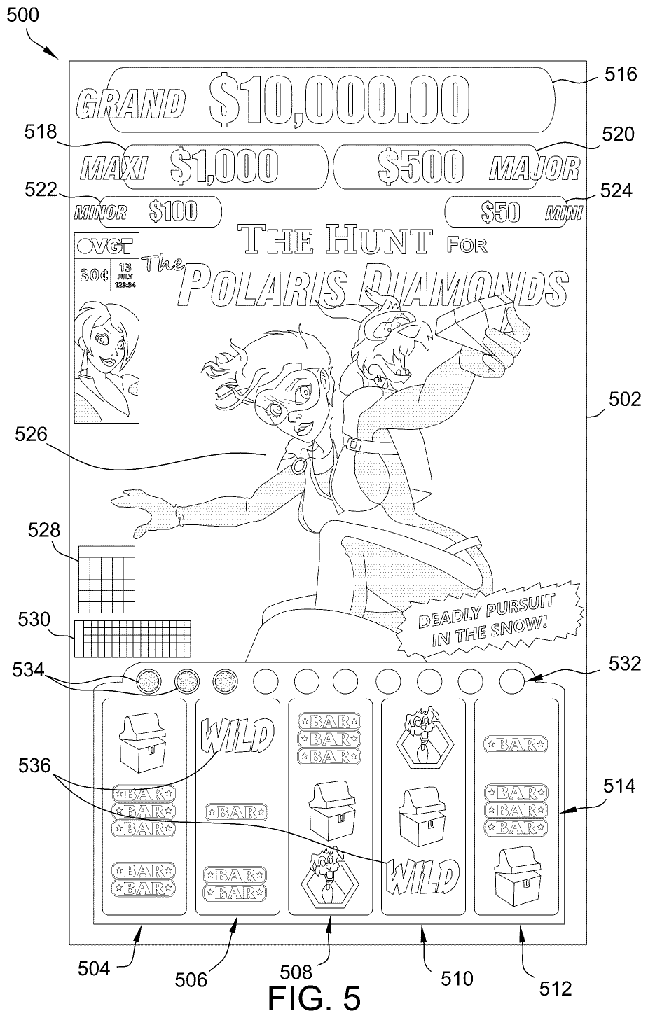

At operation 410, the processor 204 controls a display, such as display 240, to display the game play instance initiated at operation 405. Referring to FIG. 5, which shows a screen capture 500 of a game play instance presented on a user interface (UI) 502 (e.g., a UI of the UI system 302, such as game play UI 304), in an example, there are five reels 504-512 respectively displayed in one of five columns of a matrix 514 of symbol positions. The column for each reel 504-512 has a height of three rows, or three symbol positions, such that the matrix 514 is a 3×5 matrix of three rows and five columns, with 15 symbol positions total. The matrix 514 may have other configurations and different numbers of symbol positions (i.e., different numbers of columns and/or rows) than shown in the example implementation of FIG. 5. More or fewer than five reels 504-512 may be utilized for the game as well.

In the example implementation, the game UI 502 is presented on a display, such as display 240 of an electronic gaming device 200 (FIG. 2A). In other embodiments, the display may be provided on a mobile or remote device, such as a smart phone, tablet, computer, or any other suitable remote device. In some such embodiments, one or more of the steps of process 400 may be performed by one or more processors, such as a processor of the remote device and a processor of a central server in communication with the remote device.

The UI 502 may also display additional graphics associated with the electronic game. For example, the UI 502 may include, in addition to the matrix 514, jackpot meters, including a grand jackpot meter 516, a maxi jackpot meter 518, a major jackpot meter 520, a minor jackpot meter 522, and a mini jackpot meter 524. In some examples, there may be different jackpot meters and/or more or fewer than five jackpot meters 516-524 provided by the UI 502. The UI 502 may also provide a one or more metamorphical graphical elements 526, or metamorphics, that transform (e.g., by animation provided on the UI 502) to visually indicate various features of the electronic game that may be triggered during base game play. Any types of metamorphics, objects, symbols, or other graphic elements may be used and provided on the UI 502 to visually inform progress of the electronic game or features of game play. The UI 502 may also provide a credit meter indicating a credit balance of a player of the electronic game, a bet meter, and one or more input buttons (e.g., a SPIN button) that may be selected to initiate a play of the electronic game or provide some other game play input. The elements provided by the UI 502 are by way of example only, and may be displayed on alternative displays such as those described elsewhere herein. The UI 502 may also provide additional graphics other than those illustrated and described.

During game play initiated at 405, symbols from reel strips associated with the reels 504-512 are displayed in the symbol positions within the matrix 514. Although not central to an understanding of the present disclosure, each reel strip associated with one of the reels 504-512 may include a plurality of symbols arranged in a vertical column. In the example embodiment, the reel game uses virtual reel strips for the reels 504-512. Mechanical reels 504-512 and physical reel strips associated with the mechanical reels may be utilized in other implementations. The reel strips may include various basic symbols (e.g., “A”, “K”, “Q”, “J”, “10”, “9”, picture symbols), as well as feature symbols. The feature symbols may, in some examples, include feature symbols that trigger a feature game when a triggering number appear in the matrix 514, as described further below. The feature symbols may be bonus game or scatter symbols or may be cash on reel (COR) symbols (also referred to as “what you see is what you get” (WYSIWYG) symbols), which correspond to credit values awarded for each feature symbol. A number of symbols of each reel, corresponding to the number of rows of the matrix 514, is displayed in a column of symbol positions within the matrix during game play. In some implementations, a separate reel, i.e., an independent reel, may be utilized for each symbol position of the matrix 514.

To display symbols on the reels 504-512 within the matrix 514, the processor 204 may control the UI 502 to simulate rotation or spinning of one or more of the reels 504-512 within a respective column of the matrix 514. When a respective reel is simulated to halt or stop within an associated column, one or more symbols may be displayed in the symbol positions of the column. Alternatively, in implementations in which independent reels are used, each reel may be controlled to independently spin and stop and display a symbol in its respective symbol position in the matrix 514. The symbols displayed after spinning and stopping each reel in a respective column or symbol position of the matrix 514 may be referred to herein as a “reel outcome” or a “base reel game outcome” or a “base game outcome.” More broadly, an “outcome” of a reel game refers to the symbols displayed after reels are spun and stopped. Thus, a rotation and stopping of the reels 504-512 (also referred to herein as a “spin and stop sequence”) may be simulated by processor 204 within the columns or individual symbol positions of the matrix 514 to cause a reel outcome to be displayed. Each play of the reel game may include one or more reel game outcomes, that is, each play of the reel game may include a single spin and stop sequence of the reels 504-512 or multiple spin and stop sequences.

In the example implementation, reel game play displayed at operation 410 is a simulation or a facade for an underlying pre-programed or Central Determination System (CDS) game (e.g., an e-ticket lottery or a Class II bingo game) in which outcomes of the reel game recreate an output of the pre-programed or CDS game. The underlying game (e.g., an underlying e-ticket lottery or Class II bingo game) may be referred to herein as a primary game whereas the reel game simulation may be referred to as a secondary game. The primary game output may be generated by the processor 204 at operation 415 in response to a wager or a credit input received from a player for the underlying pre-programed or CDS game to initiate game play at operation 405. Although the example implementations are described herein primarily with reference to pre-programed or CDS (e.g., e-ticket lottery or Class II bingo) games, in other implementations, the reel game may be a Class III or Las-Vegas style game (e.g., a keno game). In various implementations, the reel game may be any suitable game of chance.

The primary game output has an associated award value that is determined at operation 420 after the output is generated at operation 415. As described below, one or more reel outcomes (e.g., the reel outcome shown in the screen capture 500 of FIG. 5) are presented during game play to simulate or recreate the award value of the primary game output generated at operation 415. The award value of the primary game output may be presented by the reel game simulation as a single spin and stop sequence or multiple spin and stop sequences of the reels 504-512 in the reel matrix 514 in a base game mode of the reel game simulation (shown in FIG. 5). The award value may additionally and/or alternatively be presented as an outcome of the reel game simulation in a feature game mode, as described in more detail below. The outcome(s) of the reel game simulation that present the primary game outcome may also be referred to as a “facade” or a “script.” The facade may be selected by the processor 204 based the award value, if any, associated with the primary game output or outcome presented or recreated by the facade. Each facade may be selected from (or determined based on) facade data or presentation records stored in a facade database. In such implementations, the facade database may be stored in memory 208. In other implementations, the outcome(s) of the reel game simulation may be determined randomly (e.g., in Class III games).

Example implementations of generating primary game outcomes at operation 415 will now be described. The reel game simulation and determination of facades for presenting the primary game outcomes in the example implementations will be described in greater detail below.

In the example implementation, the reel game outcome may recreate a Class II bingo game outcome. In these implementations, when the game output is generated at operation 415, a player and/or a gaming device (e.g., gaming devices 104A-104X and 200) may be provided with a bingo card, such as by a bingo gaming system server (e.g., the server 106). The UI 502 may be controlled to display the bingo card (indicated at 528 in FIG. 5). In some examples, more than one bingo card 528 may be generated and displayed. A bingo number listing (also referred to as a “ball call”) may be randomly generated, such as by bingo gaming system server 106. The UI 502 may be controlled to display the bingo number listing (indicated at 530 in FIG. 5). The bingo card 528 may be compared to the current bingo number listing 530, and the processor 204 may control the numbered cells on the bingo card 528 that match numbers in the bingo number listing 530 to be marked or “daubed” on the display. At operation 420, to determine the associated award value, the marked or daubed bingo card 528 may be evaluated against a paytable of winning bingo patterns.

The bingo number listing 530 may be continually generated until a maximum amount of numbers are listed (e.g., seventy-five numbers listed) or until a game-ending pattern is awarded to the player. A typical game-ending pattern may be a bingo card blackout pattern, in which each of the numbers of the bingo card 528 match a number displayed in the bingo number listing 530. Other game-ending patterns are also possible. When the game-ending pattern is awarded, the bingo number listing 530 is reset, and the process repeats. In some examples, a single play of the bingo game includes a wager, a bingo card 528, a bingo number listing 530, a matching of the numbers called with those on a bingo card, a determination of a bingo game outcome (and associated award value, if any), and a presentation of the associated award, if any.

To determine a bingo game outcome, the bingo card 528 may be daubed by the game controller 202 (e.g., via the processor 204) based upon a list of numbers included in the ball call 530. Once the bingo card 528 is daubed, the game controller 202 may compare the numbers daubed on the bingo card 528 to every winning pattern in a database of winning patterns (e.g., stored in memory 208) to determine one or more winning outcomes of the bingo game outcome. The number of winning patterns may be determined based upon the ball call 530. If the daubed bingo card 528 does not include a pattern that matches a pattern in the database of winning patterns, then a losing bingo outcome is determined, and no award may be provided or presented to the player. If the bingo card 528 does include a pattern that matches a pattern in the database of winning patterns, then a winning bingo outcome is determined, and an award may be presented to the player using the reel game simulation, as described below.

The bingo game outcome may, in some instances, include multiple winning patterns. Different winning patterns may be associated with different awards. The award for a winning bingo game outcome may be based on an amount wagered, an associated bingo game paytable, an associated set of rules for the bingo game, a probability (and/or likelihood) of achieving a particular bingo pattern/combination, an amount of bingo numbers needed to achieve the particular bingo pattern/combination, and/or other considerations. In some examples, the player may be awarded for multiple patterns (e.g., all winning patterns) that are matched when the daubed bingo card is evaluated against the database of winning patterns. In these examples, the award values for the multiple patterns may be combined or “coalesce” and are presented as a single award value of the reel game simulation. Alternatively, each award value for each multiple pattern may be presented separately (e.g., as multiple free spins or in a feature game). In some examples, the player may be awarded for only the highest priority pattern (e.g., the highest paying winning pattern) that is matched. In some examples, during play of a Class II bingo game, a player is provided or selects a single bingo card 528 for multiple plays of the bingo game, with a new bingo number listing 530 generated for each play of the bingo game. Other methods of play of a Class II bingo game are also possible and are within the scope of this disclosure.

In other implementations, the reel game recreates an outcome of an e-ticket lottery game (e.g., a scratch off ticket-based game outcome), that is, a prize or award value associated with an e-lottery ticket provided to the player in response to a wager or credit input. One or more ticket sets including a plurality of e-lottery tickets (also referred to herein as virtual tickets or tickets) may be stored in memory (e.g., memory 208 of the gaming device 200 and/or a memory of server 106). Each ticket may be a data structure that includes identifying data (e.g., serial numbers or other identifiers for the individual ticket) and/or gameplay-related data (e.g., an award value and/or prize associated with the ticket, if any). Each ticket set stored in memory may include any number, such as hundreds or thousands, of tickets. A greater number of tickets included in the ticket set(s) may increase the potential variability of gameplay outcomes (e.g., the variability of prizes and/or award values available for the e-ticket lottery game). In the example implementation, one ticket set is used for the e-ticket lottery game and stored in memory. In some embodiments, more than one ticket set may be stored in the memory, and each ticket set may include tickets corresponding to different prizes and/or a different overall probability of awarding a prize. For each game instance of the e-ticket lottery game, an outcome may be generated in response to a credit input or wager received from a player by selecting one ticket from the ticket set stored in memory and evaluating the selected ticket for an associated prize or award value, if any.

The processor 204 then determines the facade or reel outcome(s) for the reel game simulation to recreate the primary game outcome generated at operation 415, based on whether the primary game outcome has an associated award value (determined at operation 420). In some embodiments, the server 106 may transmit a generated primary game outcome (e.g., a generated bingo card or an e-ticket) to the gaming device 200 for a game play instance, and the gaming device may evaluate the primary game outcome to determine the associated award value and determine a facade to present the award value. The award value may alternatively be determined at the server 106 and the gaming device 200 locally determines the facade to present the award value. Additionally, or alternatively, the server 106 may evaluate the primary game outcome and determine a facade to display, and may transmit display data to the gaming device 200 which controls the reel game simulation to display the determined facade.

When the processor 204 determines at operation 420 that there is no prize or award value associated with the generated primary game outcome (i.e., a losing outcome), the processor determines at operation 425 a facade for recreating the losing outcome and controls the UI 502 to display a losing reel outcome of the reel game simulation. As described below, the processor 204 determines a facade for recreating the primary game outcome by selecting (e.g., based on a lookup) one or more presentation records for the facade. Where a facade includes multiple presentation records, the presentation records may be pre-built for the facade or the processor 204 may build the facade by selecting multiple presentation records. A table or database may be stored in a computer memory of any of EGMs 104A-104X or 200 and/or the server 106, such as memory 208, that associates primary game outcomes with facades for presenting the primary game outcomes. This table or database may be referred to as a facade database. The facade database may include pre-built facades (i.e., pre-defined sets of one or more presentation records) or may include individual presentation records from which a facade may be built by the processor 204. In some implementations, each facade in the facade database may be stored as an RNG seed.

For losing primary game outcomes, the processor 204 may select at operation 425 a presentation record from the facade database associated with the losing primary game outcome. The processor 204, at operation 430, controls the UI 502 to display the selected presentation record. With additional reference to FIG. 5, the selected presentation record for the losing primary game outcome may include a losing symbol combination displayed in the matrix 514 on the reels 504-512.

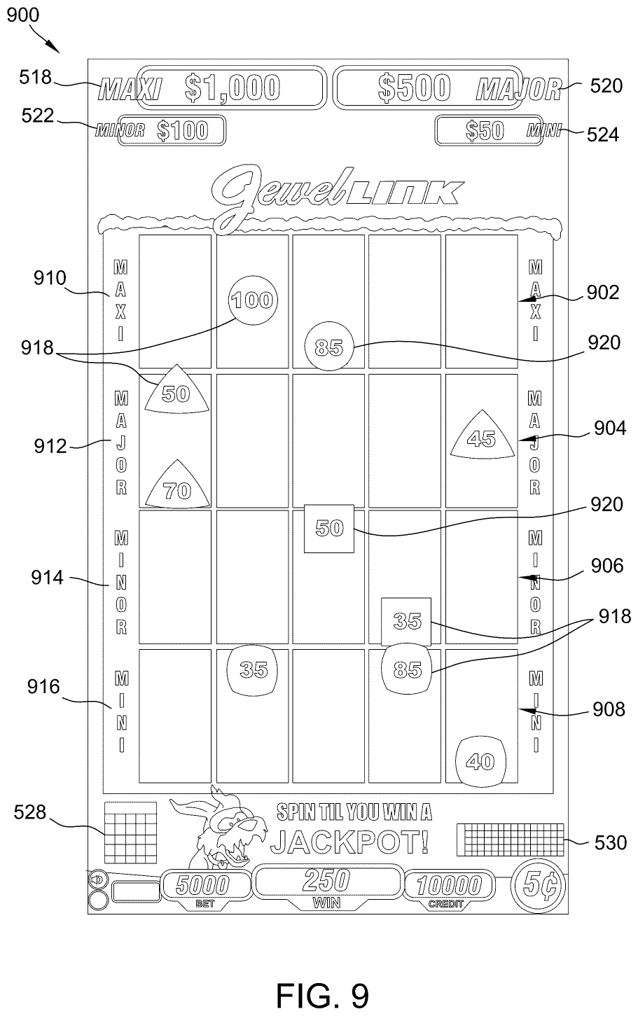

As shown in FIG. 5, the UI 502 provides a bonus token collection meter 532 above the matrix 514. During one or more play instances of the game, bonus tokens 534 (or gemstones in the illustrated example) may be “collected” by the player. Each collected token 534 is added to the bonus token collection meter 532 to increment the meter toward a triggering number of tokens that need to be collected to trigger a feature game (e.g., the hold-and-spin feature game shown in FIGS. 9-12). In the example implementation, ten tokens 534 (or gemstones) need to be collected and added to the meter in order to trigger the feature game. In other implementations, more or fewer tokens 534 may need to be collected to trigger the feature game.

At operation 435, when the primary game outcome is a losing outcome, the processor 204 determines whether the player will collect a bonus token 534 to increment the meter 532. This may be determined in various ways. For example, the collection of a bonus token 534 may be included in the presentation record selected at operation 425. That is, some of the presentation records stored in the facade database associated with losing primary game outcomes (or “losing” presentation records) may cause the processor 204 to display a losing symbol combination displayed in the matrix 514 and to add a bonus token 534 to the collection meter 532. Additionally and/or alternatively, in some implementations, the processor 204 may independently determine at operation 435 (i.e., separate from the presentation record selected at operation 425) whether to increment the collection meter 532 with a bonus token 534 in response to a losing primary game outcome. In some such implementations, the processor 204 may randomly determine whether to increment the collection meter 532 with a bonus token 534 based upon an RNG outcome generated using a random number provided by the RNG 212. The processor 204 may generate RNG outcomes for determining whether to increment the bonus token collection meter 532 at regular or irregular intervals in response to a losing primary game outcome. In some implementations, a subset of the losing presentation records stored in the facade database may be “tagged” with a random bonus token feature and, in response to one or more of the presentation records so tagged being selected at operation 425, the processor 204 generates an RNG outcome to determine whether to increment the collection meter 532 with a bonus token 534. Only a single bonus token 534, if any, is collected for any given losing primary game outcome in the example implementation. In other implementations, more than one bonus token 534 may be collected when the primary game outcome is a losing outcome.

When the processor 204 determines at operation 435 not to increment the bonus token collection meter 532, the play instance ends at operation 445. When the processor 204 determines at operation 435 to increment the bonus token collection meter 532, the processor 204 controls the UI 502 to add a bonus token 534 to the meter at operation 440, and then the play instance ends at operation 445. In either scenario, in the example implementation, when the primary game outcome is a losing outcome (as determined at operation 420), the play instance ends at 445 without a feature game being triggered. That is, in the example implementation, in no event will a bonus token 534 be added to the collection meter 532 to trigger the feature game (e.g., a hold-and-spin game) when the primary game outcome is a losing outcome.

To facilitate restricting the feature game from being triggered by the collection meter 532 in response to a losing primary game outcome, the processor 204 may check, at operation 435, whether the collection meter 532 has one fewer bonus tokens 534 than the number needed to trigger the hold-and-spin game (e.g., whether the collection meter 532 has nine out of the ten bonus tokens 534 needed to trigger the hold-and-spin game). When the primary game outcome is a losing outcome and the collection meter 532 has one fewer bonus token 534 than the triggering number, the processor 204 may automatically determine at operation 435 that a bonus token 534 will not be collected. In some such situations, the processor 204 determines that a bonus token 534 will not be collected regardless of whether the losing presentation record selected at 425 includes adding a bonus token to the collection meter 532 or a random bonus token feature described above. Additionally and/or alternatively, in some such situations, if the processor 204 is slated to generate an RNG outcome for determining whether to increment the bonus token collection meter 532, the RNG outcome may be controlled to be mapped to a bonus token 534 not being collected. In other implementations, however, a triggering number of bonus tokens 534 may be collected and the feature game (e.g., a hold-and-spin game) may be triggered even when the primary game outcome is a losing outcome.

When the primary game outcome generated at operation 415 is a winning outcome, the processor 204 determines, at operation 450, a facade for recreating the award value of the primary game outcome. For winning primary game outcomes, the processor 204 may select at operation 450 a single presentation record or multiple presentation records from the facade database for presenting the winning primary game outcome. That is, the facade may include one or more presentation records that are selected at operation 450 from the facade database to determine the facade. The number of presentation records selected at operation 450 may depend on the primary game outcome. For example, for a bingo game outcome with multiple winning patterns, a presentation record may be selected for presenting each winning pattern separately. Alternatively, the processor 204 may combine or coalesce the award values for the multiple patterns and select presentation record(s) at operation 450 for presenting the combined award.

In some implementations, a presentation record may include multiple outcomes for the reel game simulation that together present the award value of the winning primary game outcome. The multiple outcomes may be outcomes in a base game mode and/or a feature game mode of the reel game simulation. As an example, for a primary game outcome that awards 100 credits, a number of presentation records, e.g., five, ten, fifteen, or any other number of different presentation records, may exist that are capable of presenting a 100 credit award (alone or as a combination of multiple presentation records) in the reel game simulation and are stored in the facade database. The processor 204 queries the facade database and identifies these presentation records that are associated with (or capable of presenting) the 100 credit award. The facade may then be randomly selected for presenting the primary game outcome from the identified presentation records, for example, based upon an RNG outcome using a random number provided by the RNG 212.

When a facade is selected at 450 to present the primary game outcome, the processor 204, at operation 455, controls the UI 502 to display the facade that includes the selected presentation record(s) for the winning primary game outcome.

The facade displayed for the winning primary game outcome at operation 455 may include a winning symbol combination in the base game mode of the reel game simulation (FIG. 5). The winning symbol combination in the base game mode may pay out the entirety of the award value of the winning primary game outcome. In other words, the selected presentation record for the facade may not include an additional feature of the reel game simulation. In this scenario, the processor 204 may determine at 460 that the facade does not include a feature for additional award value payout. In response, the processor 204 causes the award value to be paid out at operation 465, and the play instance ends at operation 445 without a feature being displayed.

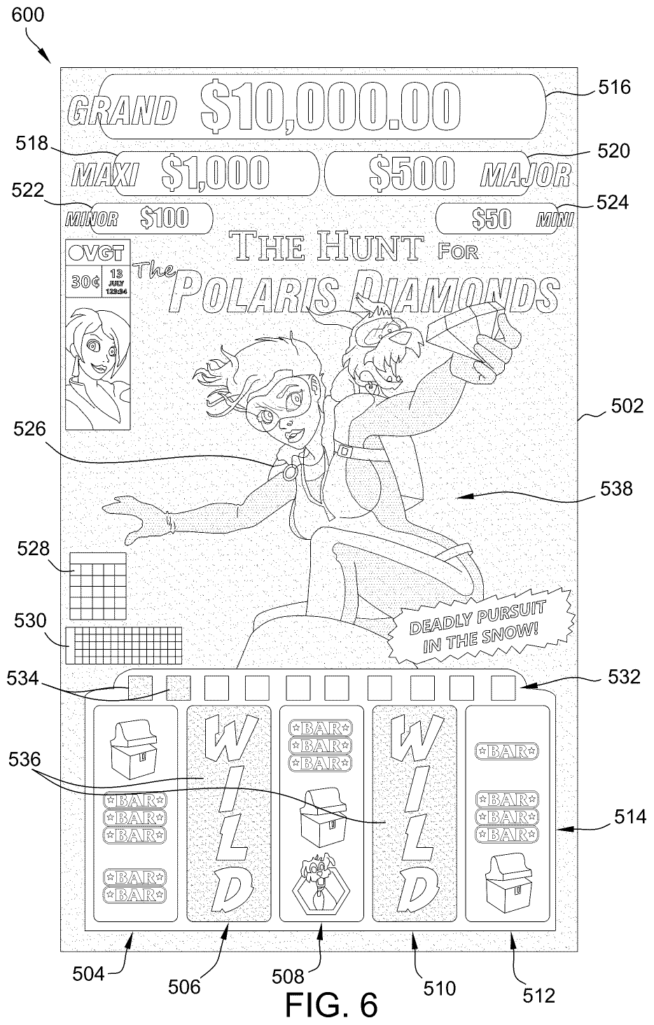

Alternatively, depending on the primary game outcome award value, the facade displayed at operation 455 may include one or more of a variety of features, in the base game mode and/or a feature game mode, that may be included in the presentation record(s) selected at operation 450 for presenting the winning primary game outcome. The features provide an additional and/or alternative award value beyond a base game reel outcome of the reel game simulation. Example features of the reel game simulation will be described in further detail below with reference to FIGS. 6-12. More, fewer, or other features than those shown or described may be included in the reel game simulation. When the facade displayed at operation 455 includes one or more of these features, the processor 204 may determine as much at operation 460. In response, the processor 204 controls the UI 502 to display the feature at operation 470 before the causing the award value to be paid out at operation 465. After the feature is displayed at 470 and the award value is paid out at 465, the play instance ends at operation 445.

The multiple different features of the reel game simulation may be utilized to provide more flexibility and variability in presenting winning outcomes of the primary game while maintaining or reducing the computing resources required to do so. To facilitate providing multiple different features, the presentation records stored in the facade database may be tiered into presentation record subsets that are each associated with a range of primary game outcome award values, such that each feature is associated with primary game outcome award values within one or more specified ranges. The ranges of award values for tiering the subsets of the presentation records that present winning primary game outcomes via the reel game simulation are not particularly limited and may vary depending on the implementation. The ranges of award values for tiering the presentation record subsets may overlap or may be mutually exclusive.

As an illustrative, non-limiting example, the presentation record subsets stored in the facade database and associated with winning primary game outcomes may be tiered as follows: for relatively low award values, a first subset of presentation records may only include winning reel outcomes in the base game mode of the reel game simulation without a feature; for relatively low to moderate award values, a second subset of presentation records may include an additional feature played in the base game mode for providing an award; and for relatively moderate to high award values, a third subset of presentation records may include an additional feature played in a feature game mode of the reel game simulation. Here again, for a given winning primary game outcome award value (e.g., a relatively low award, a relatively moderate award, or a relative high award) multiple presentation records (or multiple combinations of presentation records) capable of presenting the outcome may be stored in the facade database. The presentation records capable of presenting the outcome may be in the same or different subsets (e.g., in situations where the award value ranges associated with two or more subsets overlap). At operation 450 the processor 204 may select from all subsets that include presentation records capable of presenting the award value of the primary game outcome. For example, for a given award value that falls within the award value range for a subset of presentation records that only include winning base game reel outcomes without a feature and the award value range for a subset of presentation records that include an additional base game mode feature or feature game mode feature, the processor 204 at operation 450 may determine the facade from either subset. The facade may be randomly selected from the subsets of presentation records for the award value, for example, based upon an RNG outcome. Whether the facade includes an additional feature (beyond a base reel game outcome to present the award value) may depend, therefore, on whether presentation records including any feature exist for that award value, how the subset of presentation records are tiered, and whether the subset including presentation records that include a feature is ultimately selected by the processor 204 at operation 450. This may further increase the flexibility and variety of the game in a computationally-effective manner. Example features of the reel game simulation that may be included in presentation records stored in the facade database will now be described in more detail.

Referring to FIG. 5, the presentation record(s) selected at operation 450 for a winning primary game outcome award value may include a winning outcome of the base game mode of the reel game simulation that is displayed at operation 470 without a feature. The facade database may store such presentation records in one or more subsets each associated with an award value range (e.g., relatively low award value ranges). The winning outcomes of the base game mode that do not include a feature may be winning symbols and/or symbol combinations that are displayed in the matrix 514 and are associated with a credit award corresponding to the primary game outcome award value. Conditions for the winning outcomes of the base game mode may be defined according to a “ways” approach or may be defined as pay lines or win lines. Under the pay line approach, win conditions are defined as combinations of symbols that form pay lines (also called win lines) across at least a portion of the matrix 514. When a certain combination of symbols appears along a pay line, a win amount corresponding to that combination of symbols and that pay line may be awarded. Win amounts can vary according to the combination of symbols and according to the particular pay line along which the combination of symbols appears. In other implementations, the win conditions are defined according to a ways approach, in which symbols displayed at symbol display positions within one of the columns of the matrix 514 can be used to form symbol combinations (one symbol per reel in a combination) with the symbols displayed at designated symbol display positions of each of the other columns of the matrix 514. For example, in the example matrix 514 in which there are five reels 504-512, and three symbol display positions for each reel 504-512, each possible path through the symbol display position(s) of the respective reels may provide a way to win. The total number of ways to win in the matrix 514 may be determined by multiplying the number of active display position(s) of each reel 504-512, where the active display position(s) for a reel are all display positions in the matrix 514. As a result, under the ways approach, there are 3×3×3×3×3=243 ways to win for the matrix 514.

Still referring to FIG. 5, the presentation record(s) selected at operation 450 for a winning primary game outcome award value may include one or more features that are displayed at operation 470 in the base game mode of the reel game simulation. Depending on the presentation record selected, the base game mode feature may be displayed in addition or in the alternative to a winning symbol combination in the matrix 514 as described above. In one example base game mode feature, stacks of WILD symbols 536 (e.g., a WILD symbol 536 in each row of a reel) may appear on one or more of the reels 504-512. Stacks of WILD symbols 536 are shown in FIG. 6; only single instances of WILD symbols 536 are shown in FIG. 5. The stacks of WILD symbols 536 may appear in the result of the base reel game (i.e., as part of the spin and stop sequence) or may replace the symbols displayed on one of the reels after the spin and stop sequence of the facade concludes. The stacks of WILD symbols 536 may increase the variety and flexibility in providing awards of the reel game simulation. For example, the stacks of WILD symbols 536 may visually indicate or create the perception that the number of winning symbol combinations in the matrix 514 is increased, as each WILD symbol 536 is “evaluated” as a wild. Additionally, the UI 502 may visually indicate that stacks of WILD symbols 536 trigger a bonus feature game (e.g., the Stacked Wilds Respin Feature game described below with reference to FIG. 6). In the example implementation, stacks of WILD symbols 536 are limited to reels 506, 508, and 510. In other implementations, stacks of WILD symbols 536 may potentially appear on any of the reels 504-512.

In another example base game mode feature, at the conclusion of the base reel game, one or more of the reels 504-512 may be “nudged” to convert a losing reel outcome to a winning reel outcome (i.e., by forming one or more winning symbol combinations in the matrix 514 as the reel(s) are nudged). This base game mode feature may be provided by the UI 502 with an animation effect. For example, a metamorphic 526 (e.g., a bucking walrus) may appear adjacent to the reels 504-512 and the UI 502 may display the metamorphic 526 as nudging one or more of the reels 504-512 to form the winning symbol combination(s) in the matrix 514.

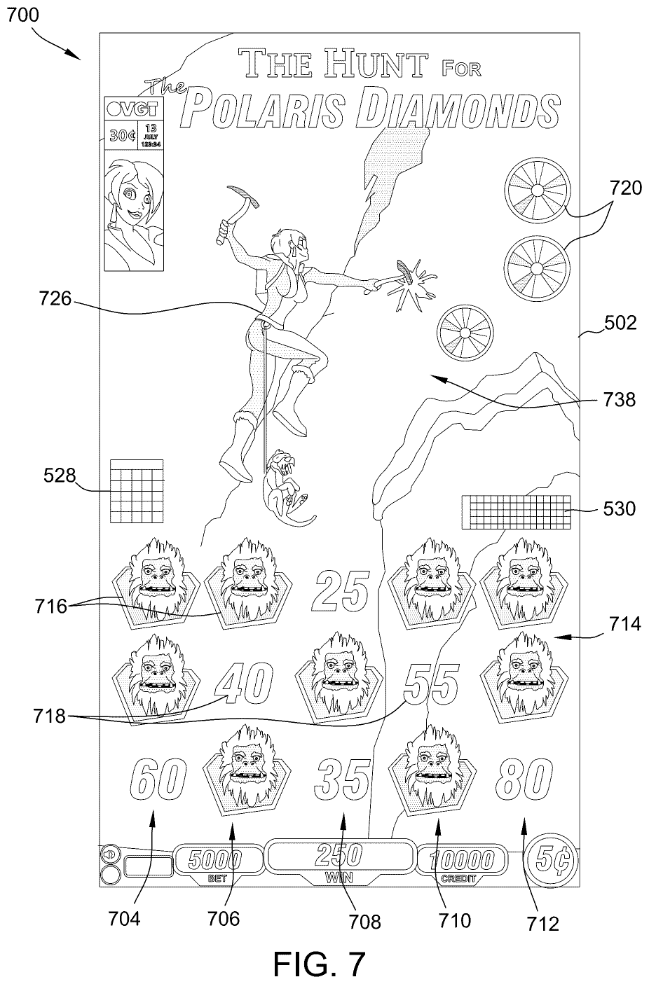

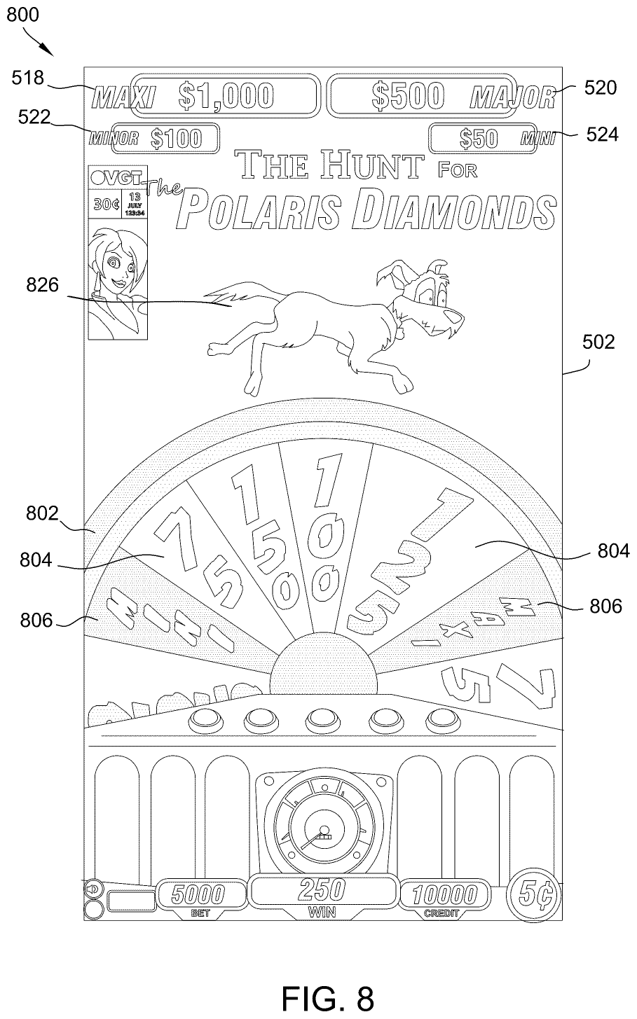

In yet another example base game mode feature, during the spin and stop sequence of the reels 504-512 in the base game mode, the UI 502 controls one or more symbol positions to “freeze.” When the spin and stop sequence concludes and the reel game outcome is displayed in the remaining (unfrozen) symbol positions, the UI 502 controls the frozen symbol positions to “crack” and reveal a prize that is awarded in addition to any winning symbol combination in the matrix 514. Example prizes that may be revealed by the cracked symbol positions include credit values (e.g., a COR symbol), credit multipliers, WILD symbols 536, special symbols that form part of certain winning symbol combinations (e.g., picture symbols), a bonus token 534 that is subsequently added to the collection meter 532, or a bonus game symbol that triggers a pick bonus game (e.g., the pick bonus game shown in FIGS. 7 and 8 described below). This base game mode feature may also be provided by the UI 502 with an animation effect. For example, the UI 502 may display animation of a metamorphic 526 (e.g., a skier firing a snowball) that causes the symbol position(s) to freeze during the spin and stop sequence of the base reel game.

Referring now to FIGS. 6-12, the presentation record(s) selected at operation 450 for the primary game outcome award value may include one or more features that are displayed at operation 470 in a feature game mode of the reel game simulation as a bonus game. One or more of the features in the feature game mode may be provided by the UI 502 or a different UI (e.g., a bonus play UI 306 provided by the UI system 302). Reference here to the UI 502 is inclusive of implementations where more than on UI is used (e.g., one or more game play UI 304 and one or more bonus play UI 306). Each UI 502 may include similar display areas and/or elements as each other UI 502, or may include more, fewer, or different display areas and/or elements. Each feature or one or more of the features that may be displayed in the feature game mode at operation 470 may be played on several displays (e.g., a primary display and a secondary display of the gaming device). Additionally and/or alternatively, each feature or one or more of the features may be played on a single display and/or on two or more than two displays. During the feature game mode, the bingo card 528 and bingo number listing 530 generated at operation 415 may continue to be displayed by the UI 502.

The presentation records stored in the facade database that include features displayed in the feature game mode may be associated with relatively medium to high award values of the primary game outcome. Such presentation records that include feature game mode features may also be tiered into different subsets depending on the feature or bonus game included in the presentation record. That is, one subset or multiple subsets of presentation records including a feature game mode feature may be stored in the facade database. For example, one or some of the example feature or bonus games described herein may be included in presentation records in a subset associated with relatively medium award values of the primary game outcome while another or some other of the example feature or bonus games described herein may be included in presentation records in a subset associated with relatively high award values. This may facilitate increasing the variability and flexibility in presenting winning outcomes of the primary game.

FIG. 6 is a screen capture 600 of an example “on-reel” respin feature of the reel game simulation. Presentation record(s) that include the on-reel respin feature may also include a visual indication, provided by the UI 502, that the respin feature is triggered when certain symbol(s) or symbol combination(s) appear in the reel outcome of the base game mode. In the example implementation, the UI 502 may visually indicate that the on-reel respin feature is triggered when one or more stacks of WILD symbols 536 appear on the reels. The on-reel respin feature may not be automatically “triggered” when one or more stacks of WILD symbols 536 appear in the base reel game outcome. That is, some presentation records may include a reel outcome with one or more stacks of WILD symbols 536 without the on-reel respin feature, while other presentation records may include a reel outcome with one or more stacks of WILD symbols 536 that “trigger” the on-reel respin feature. Accordingly, the UI 502 may provide the visual indication (e.g., an animation effect) to visually inform whether the on-reel respin feature is triggered when one or more stacks of WILD symbols 536 appear in the base reel game outcome. In the example implementation, the UI 502 may cause display of a blizzard animation 538 (shown in FIG. 6) around one or more of the metamorphics 526 (e.g., skiers) to visually indicate that the on-reel respin feature is triggered in response to the stacks of WILD symbols 536 appearing on the reels 506 and 510.

When the on-reel respin feature is triggered, the animation effect 538 is displayed around the metamorphics 526 for a predetermined duration. The duration of the animation effect 538 may depend on the award value of the primary game outcome-relatively higher award values resulting in a longer animation effect 538. As the animation effect 538 is displayed, the stacked WILD symbols 536 become “frozen” in place, and the remaining reels (e.g., reels 504, 508, and 512) respin. The number of respins corresponds to the duration of the animation effect 538. That is, a relatively greater award value of the primary game outcome results in a longer animation effect 538 and greater number of respins. For each respin outcome, the stacked WILD symbols 536 are evaluated as wilds and winning symbol combinations are paid out as well. The UI 502 may visually inform progress of the on-reel respin feature by gradually decreasing the “severity” of the blizzard and/or causing display of an effect that the “frozen” stacks of WILD symbols 536 are beginning to “crack.” In the example implementation, the frozen stacks of WILD symbols 536 begin to crack on the penultimate respin, and “melt” on the last respin. Thereafter, the stacks of WILD symbols 536 become normal stacks of WILD symbols, and the animation effect 538 ends. Here again, the duration of the respin feature may be dependent on the award value of the primary game outcome, and the number of respins of the on-reel respin feature may be determined based on the number of respins necessary to recreate the primary game outcome award value (or some portion thereof) and/or number of winning patterns of the primary game outcome (or some portion thereof).

Other on-reel features may be included in the presentation records stored in the facade database and displayed at operation 470 when the presentation record is selected at operation 450. For example, some presentation records may include a free spin feature that includes one or more additional spins of the reels 504-512 or different (e.g., feature) reels. As described above for the on-reel respin feature of FIG. 6, the presentation record may include a visual indication displayed by the UI 502 that the free spin feature is triggered when certain symbol(s) or symbol combination(s) appear in the reel outcome of the base game mode. For example, the presentation records as part of the base game may visually indicate that a triggering number of special symbol types displayed in the matrix 514 triggers a free spin feature game. As part of the facade for the free spin feature, the UI 502 may cause display of one or more indications that the free spins feature game is distinct from the base game. For example, the UI 502 may display an overlaid translucent or transparent colored graphic effect, such as a red color overlay or a “red screen.” The red screen may be displayed for the duration of the free spin feature game. Additionally and/or alternatively, the UI 502 may cause display of animation (e.g., words, symbols, letters, metamorphics, and/or other visual effects) to visually distinguish the free spins feature game from the base game. For example, the metamorphic 526 displayed on the UI 502 may be transformed from an inactive state to an active state to visually indicate that the feature game is initiated, and/or some animation or other graphical effect may be displayed on the UI 502. The number of spins of the on-reel free spin feature may be determined based on the number of spins necessary to recreate the primary game outcome award value (or some portion thereof) and/or number of winning patterns of the primary game outcome (or some portion thereof).

FIG. 7 is a screen capture 700 of an example “off-reel” pick bonus game of the reel game simulation displayed at operation 470. The presentation records that include the pick bonus game may include a visual indication displayed by the UI 502 that the pick bonus game is triggered when certain symbol(s) or symbol combination(s) appear in the reel outcome of the base game mode. For example, the presentation records as part of the base game may visually indicate that a triggering number of special symbol types (e.g., three or more mountain picture symbols) displayed in the matrix 514 triggers a pick bonus game. In the example implementation, the presentation records that include a pick bonus game may include a visual indication, provided by the UI 502, that the pick bonus game is triggered in response to three or more bonus symbols appearing on any of the reels 504, 508, and 512. In other implementations, the bonus symbols that “trigger” the pick bonus game may appear on any of the reels 504-512 or any sub-combination thereof. Additionally and/or alternatively, the presentation records as part of the base game may visually indicate that a certain symbol combination (e.g., the word “BONUS” being spelled across the five reels 504-512) displayed in the matrix 514 triggers a pick bonus game.

The example pick bonus game of FIG. 7 includes display, by the UI 502, of pick icons 716 arranged in a matrix (e.g., pick icon matrix 714) including a number of rows (or pick icon positions) and columns 704-712. The pick icon matrix 714 has a 3×5 configuration in the illustrated example, each column 704-712 having three positions for three pick icons 716 such that the matrix 714 includes fifteen pick icons 716 total. The configuration of the pick icon matrix 714 may vary, for example, the pick icon matrix 714 may include more pick icons 716 for relatively greater award values of the primary game outcome or fewer pick icons for relatively lower award values of the primary game outcome. Alternatively, the number of pick icons 716 may be consistent and the number of picks available to the player may change depending on the award value of the primary game outcome. Thus, for relatively lower award values, the player may be limited to fewer picks than the total number of pick icons 716 displayed (e.g., fewer than fifteen picks). In the illustrated example, each pick icon 716 is a picture of a Yeti, and may be different shapes, pictures, etc. in other examples.

During the pick bonus game, a player selection of a pick icon 716 may reveal an outcome or a prize 718 of the pick icon. The prize 718 of a pick icon 716 may be displayed in conjunction with a transformation or animation of the pick icon 716. The prize 718 of each selected pick icon 716 may be a pick icon credit value or some other prize (e.g., a multiplier). In the example of FIG. 7, pick icon credit values are displayed for the selected pick icons 716. As described above, the player may be awarded fewer picks than the number of pick icons 716 in the matrix 714. In some examples, the outcome of pick icon 716 that is not selected by a player may also be revealed at the conclusion of the pick bonus game. In CDS or Class II examples, the reveal order of the prizes 718 of selected pick icons 716 may be predetermined. A predetermined order of prizes 718 for the selected pick icons 716 will be successively displayed as selections of pick icons 716 are made, regardless of the location of the selected pick icons 716 in the matrix 714. This provides a perception of randomization, although the underlying outcomes of the selected pick icons 716 are predetermined. In Class III examples, the reveal order of prizes 718 of the selected pick icons 716 may be random, that is, the prizes 718 may be randomly determined with each selection of a pick icon 716.

The UI 502 may provide one or more animation effects 738 for the duration of the pick bonus game (i.e., the animation effect(s) 738 may be displayed in conjunction with the selected pick icons 716). In the example implementation, the animation effect 738 is an animated metamorphic 726 (e.g., a mountain climber climbing up a mountain as shown in FIG. 7). A relatively greater award value of the primary game outcome may correspond to a longer duration of the animation effect. The duration of the pick bonus game and the number of picks award to the player (i.e., the number of pick icons 716 the player is able to select) may also correspond to the duration of the animation effect 738. A longer duration of the animation effect 738 may correspond to the player being allowed to select more pick icons 716 to reveal more prizes 718. Thus, a relatively greater award value of the primary game outcome provides a longer duration of the animation effect 738 and more pick selections for the player.

During the animation effect 738 of the pick bonus game provided in conjunction with selections of the pick icons 716, one or more additional prizes 720 may be awarded to the player. The UI 502 may control the display to visually indicate that, as the animation effect 738 continues, more additional prizes 720 are awarded. In the illustrated example, the UI 502 controls the animation effect 738 to indicate that the mountain climber metamorphic 726 uncovers the additional prizes 720 during the climb up the mountain. A longer duration of the animation effect 738 may translate to the metamorphic 726 uncovering a greater number of additional prizes 720. In the example implementation, the additional prizes 720 include wheel bonus symbols (shown in FIG. 7) that are applied to a secondary wheel bonus game (FIG. 8) displayed at the conclusion of the pick bonus game. The additional prizes 720 may additionally and/or alternatively include credit values, “boosts” for all or a subset of the prizes 718 of the selected pick icons 716, a bonus token 534 that is subsequently added to the collection meter 532 (FIG. 5) when the simulation returns to the base game mode, or any other suitable prize. The pick bonus game continues until the animation effect 738 ends, which is indicated in the example implementation as the mountain climber metamorphic 726 reaching the top of the mountain.

FIG. 8 is a screen capture 800 of the secondary wheel bonus game or “big wheel bonus” that is displayed at the conclusion of the pick bonus game of FIG. 7. The big wheel bonus includes a spinning wheel 802 that spins and stops on a wedge of the wheel with a prize identifier thereon. The prize identifiers include credit prizes 804 and jackpot prizes 806 in the illustrated example. Other prizes may be included on the wedges of the wheel 802 (e.g., multipliers, bonus tokens 534, etc.). The jackpot prizes 806 correspond to one of the jackpot meters 518-524, which are also displayed by the UI 502 in conjunction with the big wheel bonus. A grand jackpot prize is not awarded during the big wheel bonus, and so the grand jackpot meter 516 is not shown on the UI 502 in FIG. 8.

Referring back to FIG. 7, as described above, wheel bonus symbols may be uncovered by the animation effect 738 as one or more of the additional prizes. In response, when the big wheel bonus shown in FIG. 8 is displayed by the UI 502, the UI controls the wheel 802 to remove a wedge having the lowest award or prize (e.g., the 75 credit wedge in FIG. 8). Alternatively, the wedge having the lowest award or prize may be combined with an adjacent wedge for each wheel bonus symbol uncovered by the animation effect 738 during the pick bonus game. A metamorphic 826 may be provided by the UI 502 in conjunction with the spinning wheel 802. In the illustrated example, the metamorphic is a dog displayed by the UI 502 as running over the top of the wheel 802.

During the big wheel bonus, the wheel 802 is spun and stopped and the prize of the wedge landed on is awarded to the player in addition to the prizes awarded during the pick bonus game. In CDS or Class II examples, the prize awarded at the conclusion of the big wheel bonus is, similar to the reveal order of the selected pick icons 716, predetermined and corresponds to the outcome of the primary game. In Class III examples, the prize awarded at the conclusion of the big wheel bonus is random. In both examples, the UI 502 may control the metamorphic 826 to “change” the prize awarded by the big wheel bonus (e.g., by showing the dog metamorphic 826 nudging the wheel 802 to land on a wedge having a greater prize). After the pick bonus game and the big wheel bonus conclude, the prize is awarded at operation 465 and the game instance ends at operation 445 (FIG. 4).

FIGS. 9-11 are screen captures 900, 1000, and 1100, respectively, of the hold-and-spin game that is “triggered” when the collection meter 532 (FIG. 5) is filled with the triggering number of bonus tokens 534 (e.g., ten bonus tokens in the illustrated example). As described above, bonus tokens 534 may be added to the collection meter 532 (e.g., at operation 440 in FIG. 4) in response to a losing primary game outcome, however, this does not result in the triggering of the hold-and-spin game/filling up the collection meter 532. Rather, the collection meter 532 only reaches the required triggering number of bonus tokens 534 in response to a winning primary game outcome (such that the hold-and-spin game is reserved for presenting winning outcomes). Moreover, the triggering number of bonus tokens 534 may be reached in the collection meter 532 only when there is a relatively high award value of the primary game outcome. This can be controlled, for example, by reserving the addition of the tenth (or final one or more) bonus token 534 in the collection meter 532 to presentation records stored in the facade database that are associated with high primary game outcome award values. The remaining number of bonus tokens 534 leading up to the tenth or final one or more bonus tokens 534 may be provided as described above in presentation records associated with relatively lower (e.g., low to medium) award values, without triggering the hold-and-spin feature game. In some examples, presentation records associated with relatively high primary game outcome award values may include the addition of the last two or more bonus tokens 534 to trigger the hold-and-spin feature game. Moreover, for particularly large award values of the primary game outcome, the associated presentation records may include an automatic triggering of the hold-and-spin feature game regardless of the number of bonus tokens 534 in the collection meter 532. This could be visually indicated by the UI 502 causing however many bonus tokens 534 are needed in the collection meter 532 to be added thereto to trigger the hold-and-spin feature game.

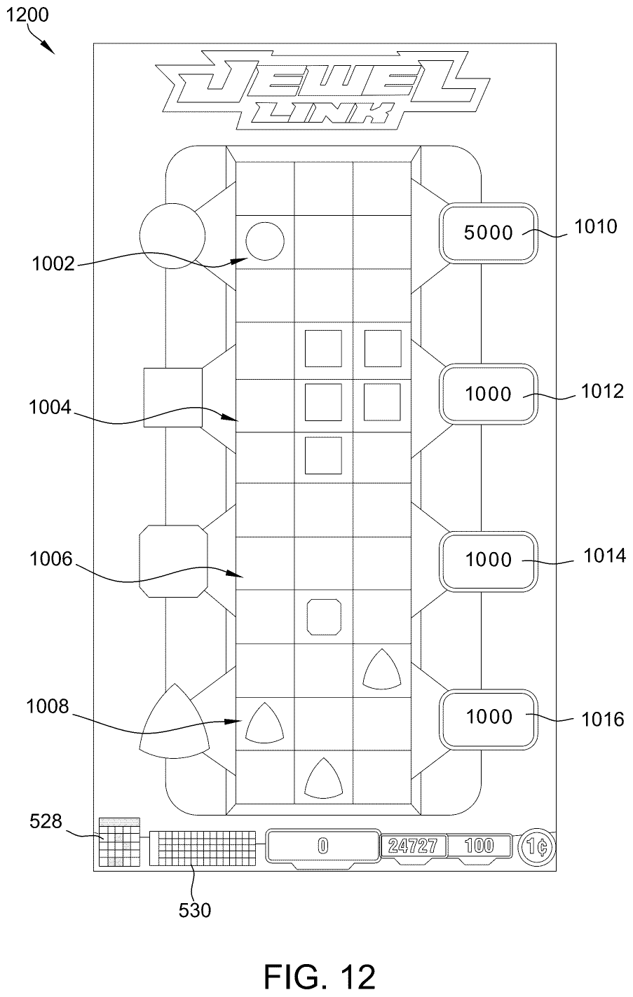

The hold-and-spin feature game shown in FIGS. 9-11 is a “jewel link bonus” game that includes four matrices or bonus play areas 902, 904, 906, 908. Each bonus play area 902-908 is a 3×5 matrix in the illustrated example, with fifteen symbol positions each. The configuration of the bonus play areas 902-908 may vary in other examples, such as the alternative example screen capture 1200 of FIG. 12. For example, as shown in FIG. 12, bonus play areas 1002-1008 of the hold-and-spin feature game may be 3×3 matrices, with nine symbol positions each. The bonus play areas 1002-1008 correspond to and have similar functionality as bonus play areas 902-908 in FIGS. 9-11, and any description of the bonus play areas 902-908 applies to the bonus play areas 1002-1008 unless expressly stated otherwise or the context clearly indicates otherwise. Additionally, any description of game play of the hold-and-spin game with reference to FIGS. 9-11 applies equally to FIG. 12 unless expressly stated otherwise or the context clearly indicates otherwise.

The configuration of the bonus play areas 902-908 (or 1002-1008) may vary depending on the award value of the primary game outcome (e.g., greater award values could result in larger bonus play areas). Each bonus play area 902-908 is associated with a prize, indicated by the prize identifiers 910, 912, 914, 916 respectively displayed adjacent to the bonus play areas 902-908. The prizes may be credit values, jackpots, multipliers, or some other prize. In the illustrated example of FIGS. 9-11, the prizes for the play areas 902-908 are each a jackpot. In particular, the play area 902 is associated with the maxi jackpot, the play area 904 is associated with the major jackpot, the play area 906 is associated with the minor jackpot, and the play area 908 is associated with the mini jackpot. The jackpot meters 518-524 are also displayed by the UI 502 in conjunction with the play areas 902-908.

In the alternative example of FIG. 12, prize identifiers 1010, 1012, 1014, 1016 are respectively displayed adjacent to the bonus play areas 1002-1008, and each prize identifier is a credit value. The credit values of the prize identifiers 1010-1016 may be the same or may vary between the bonus play areas 1002-1008. In the illustrated example of FIG. 12, the play areas 1002-1006 are each associated with a 1000 credit value, and the play area 1008 is associated with a 5000 credit value. The jackpot meters 518-524 are omitted from FIG. 12 since the prize identifiers 1010-1016 are not associated with jackpots. In some examples, the credit values of the prize identifiers 1010-1016 may progressively change (e.g., progressively increase) from the play area 1002 to the play area 1008.

At the beginning of the hold-and-spin game, shown in FIG. 9, ten play symbols 918, or jewel symbols 918, are populated at symbol positions across the play areas 902-908. The number of jewel symbols 918 populated at the initiation of the hold-and-spin game may correspond to the number of bonus tokens 534 collected to trigger the hold-and-spin game. Thus, while there are ten jewel symbols 918 that are initially populated in the play areas 902-908 in the illustrated example, more or fewer jewel symbols 918 may be populated depending on the number of bonus tokens 534 collected. The UI 502 may provide an animation effect for populating the jewel symbols 918 in their respective symbol positions in the play areas 902-908. For example, the UI 502 may cause display of the jewel symbols 918 falling down from the top of the display and landing in their respective symbol positions. In CDS or Class II examples, the symbol positions in which the jewel symbols 918 land is predetermined as part of a predetermined outcome of the hold-and-spin game that corresponds to the outcome of the primary game. In Class III examples, the symbol positions for the jewel symbols 918 at the beginning of the hold-and-spin game may be random.

The jewel symbols 918 have different shapes/are different symbol types depending on the play area 902-908 in which they land. In the illustrated example, the jewel symbols 918 that land in the play areas 902-908 are different types of gems. In other examples, the jewel symbols 918 may differ in other respects. In yet other examples, the jewel symbols in each play area 902-908 may be the same type of symbols (e.g., the same type of gems).

In the illustrated example, each jewel symbol 918 includes a prize identifier 920. The jewel symbols 918 are COR symbols in the example implementation, and each prize identifier 920 indicates a credit value awarded on each of the jewel symbols 918 that appear. The prize identifiers may include other prizes as well (e.g., multipliers). The prizes awarded on each jewel symbols 918 may be generally consistent between the play areas 902-908, or may change (e.g., change in value) between the play areas 902-908. For example, jewel symbols 918 that appear in the play area 902, associated with the maxi jackpot, may also have relatively higher prize values than jewel symbols landing in the other play areas 904-908, and the values may gradually decrease down the line (from play area 904 to play area 908). In CDS or Class II examples, the prizes awarded on the jewel symbols 918 that land are predetermined as part of a predetermined outcome of the hold-and-spin game that corresponds to the outcome of the primary game. In Class III examples, the prizes awarded on the jewel symbols 918 may be randomly determined (e.g., using one or more pay tables stored in memory).

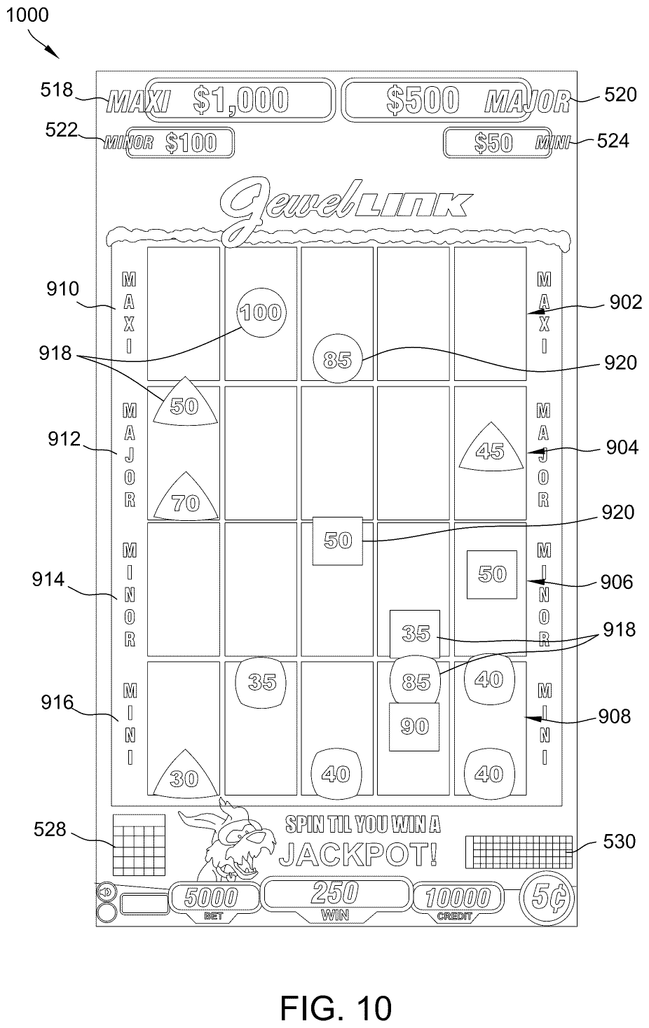

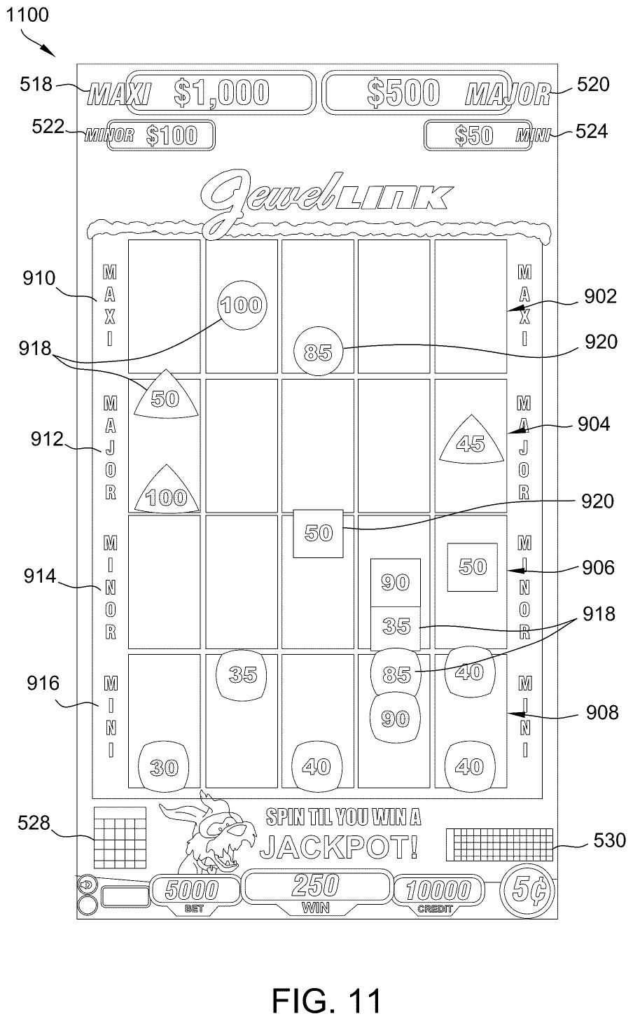

The screen captures 1000 and 1100 of FIGS. 10 and 11 depict play of the hold-and-spin game initiated as shown in the screen capture 900 of FIG. 9. During play, the jewel symbols 918 initially populated in the play areas 902-908 are held during each spin of the feature game in their respective symbol positions. Reels (e.g., feature game reels) are spun and stopped in each column of each play area 902-908. Alternatively, independent reels may be used and are spun and stopped in each symbol position of each play area 902-908. Additional jewel symbols 918 may appear during each spin and are also held in their respective symbol positions for subsequent spins. Each additional jewel symbol 918 that appears during play of the feature game includes a prize identifier 920. The symbols positions of the additional jewel symbols 918 as well as the credit values and/or prize identifiers associated with the additional jewel symbols 918 that appear during the hold-and-spin game may be predetermined (in CDS or Class II games) or randomly selected from pay tables stored in memory (in Class III games). For each subsequent spin of the hold-and-spin game, the reels are respun for the remaining symbol positions of the play areas 902-908 that are not populated with a jewel symbol 918.

The example hold-and-spin game continues until one of the play areas 902-908 is completely populated with jewel symbols 918. At the conclusion of the hold-and-spin game, the prizes awarded on each of the jewel symbols 918 in all play areas 902-908 are provided to the player. The prize indicated by the prize identifier 910-916 displayed adjacent to the completely populated play area 902-908 is also awarded to the player. These are paid out at operation 465 along with any award of the base game mode. The game instance then ends at operation 445, and the collection meter is reset. In other examples, the hold-and-spin game may conclude before any of the play areas 902-908 is completely populated. For example, the hold-and-spin game may include a predetermined number of spins, with or without a free spin reset, and the game concludes when either one of the play areas 902-908 is completely populated with jewel symbols 918 or the number of spins remaining reaches zero.

As described above, the jewel symbols 918 may each be a different symbol type (e.g., a different gem) depending on the play areas 902-908 in which they land. In the example implementation, jewel symbols 918 displayed in the play area 902 are diamonds, jewel symbols 918 displayed in the play area 904 are rubies, jewel symbols 918 displayed in the play area 906 are emeralds, and jewel symbols 918 displayed in the play area 908 are sapphires. These gems are provided by way of example only, and the associated gem type for each play area 902-908 may vary. For example, the screen capture 1200 of FIG. 12 shows that the play areas 1002-1008 are associated with different gem types as compared to the play areas 902-908. Any types of gems may be used for the jewel symbols 918, or the jewel symbols 918 displayed in the play areas 902-908 (or 1002-1008) may differ in other respects (e.g., size).

During play of the hold-and-spin game, jewel symbols 918 of a particular type (e.g., a particular gem) may be displayed in the incorrect play area 902-908 for that type. For example, the screen capture 1000 of FIG. 10 illustrates a ruby jewel symbol 918 and an emerald jewel symbol 918 displayed in the play area 908 (which is designated for sapphires). When this occurs, in the example implementation, a jewel symbol 918 is duplicated in the “correct” play area 902-908 for the incorrectly populated jewel symbol(s) 918, which is then converted to the correct symbol type. The duplication involves either i) populating a jewel symbol 918 in the corresponding symbol position of the correct play area 902-908 (i.e., the same column and row as the jewel symbol 918 in the incorrect play area 902-908) if that symbol position is unpopulated or ii) aggregating or combining the prize values awarded on the jewel symbols 918 in the incorrect and the correct play areas 902-908 on the prize identifier 920 of the jewel symbol 918 populated in the symbol position of the correct play area 902-908.

This is illustrated in the sequence between the screen capture 1000 of FIG. 10 and the screen capture 1100 of FIG. 11. As described above, FIG. 10 shows two jewel symbols 918 with incorrect symbol types in the play area 908-a ruby jewel symbol 918 in the bottommost row of the first column and an emerald jewel symbol 918 in the middle row of the fourth column. The prize values awarded on these jewel symbols 918 of the incorrect symbol types are then duplicated in the corresponding symbol positions of the correct play areas—the play area 904 for the ruby jewel symbol 918 and the play area 906 for the emerald jewel symbol 918. As shown in FIG. 10, the middle row of the fourth column of the play area 906 is unpopulated, and as a result, in FIG. 11, this symbol position is populated with an emerald jewel symbol 918 having the same prize identifier 920 (90 credits) as the emerald jewel symbol 918 that appeared in the play area 908. The bottommost row of the first column of the play area 904 is already populated with a jewel symbol 918, and as a result the prize identifier of this jewel symbol 918 is increased by the 30 credits awarded on the ruby jewel symbol 918 that appeared in the play area 908 (from 70 credits to 100 credits as shown in the sequence). As shown in FIG. 11, the jewel symbols 918 that were initially of the incorrect symbol type are then converted to the correct symbol type (sapphires) when the jewel symbols 918 and their prize identifiers 920 are duplicated in the correct play areas.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g., an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic gaming system comprising:
a display device configured to display an electronic game that includes a base game mode and a feature game mode;
a processor; and
a memory storing instructions, which when executed by the processor, cause the processor to:
generate an output in response to a player input at a gaming device;
evaluate the output to determine an award value;
select, based on the award value, a presentation record of the electronic game from a plurality of presentation records stored in the memory, wherein the plurality of presentation records includes:
a first presentation record set including presentation records each including an outcome of the base game mode without a feature;
a second presentation record set including presentation records each including a feature of the base game mode; and
a third presentation record set including presentation records each including a feature of the feature game mode;
wherein the first presentation record set is associated with a first range of award values, the second presentation record set is associated with a second range of award values different from the first range, and the third presentation record set is associated with a third range of award values different from the first range and the second range; and
cause display of the selected presentation record on the display device.

2. The electronic gaming system of claim 1, wherein the output is a bingo game outcome.

3. The electronic gaming system of claim 1, wherein the feature of the feature game mode comprises a first feature, the first feature being a hold-and-spin game that includes first and second play areas, wherein, when the selected presentation record is from the third presentation record set, the instructions, when executed, further cause the processor to:
cause display of a visual indication that the hold-and-spin feature game is triggered;
initiate play of the hold-and-spin game by populating a first type of feature symbol in the first play area and a second type of feature symbol in the second play area, each of the populated feature symbols associated with an award value; and
cause display of one or more spins of the hold-and-spin game, wherein, when a feature symbol of the first type appears in the second play area, the first play area is populated with an additional feature symbol of the first type and the feature symbol of the first type in the second play area is converted to the second type.

4. The electronic gaming system of claim 3, wherein, when the feature symbol of the first type appears in the second play area, the first play area is populated with the additional feature symbol of the first type in a corresponding symbol position as the feature symbol of the first type appearing in the second play area.

5. The electronic gaming system of claim 4, wherein, when the corresponding symbol position is already populated with an existing feature symbol, the award value of the existing feature symbol is increased by the award value of the feature symbol of the first type appearing in the second play area.

6. The electronic gaming system of claim 3, wherein the visual indication that the hold-and-spin feature game is triggered is a triggering number of bonus tokens collected.

7. The electronic gaming system of claim 3, wherein the feature of the feature game mode comprises a second feature, the second feature being a pick bonus game.

8. A non-transitory computer-readable medium containing instructions stored thereon, which when executed by a processor, cause the processor to:
control a display device to display an electronic game that includes a base game mode and a feature game mode;
generate an output in response to a player input at a gaming device;
evaluate the output to determine an award value;
select, based on the award value, a presentation record of the electronic game from a plurality of presentation records stored in a memory, wherein the plurality of presentation records includes:
a first presentation record set including presentation records each including an outcome of the base game mode without a feature;
a second presentation record set including presentation records each including a feature of the base game mode; and
a third presentation record set including presentation records each including a feature of the feature game mode;
wherein the first presentation record set is associated with a first range of award values, the second presentation record set is associated with a second range of award values different from the first range, and the third presentation record set is associated with a third range of award values different from the first range and the second range; and
control the display device to display the selected presentation record.

9. The non-transitory computer-readable medium of claim 8, wherein the output is a bingo game outcome.

10. The non-transitory computer-readable medium of claim 8, wherein the feature of the feature game mode comprises a first feature, the first feature being a hold-and-spin game that includes first and second play areas, wherein, when the selected presentation record is from the third presentation record set, the instructions, when executed, further cause the processor to:
control the display device to display a visual indication that the hold-and-spin feature game is triggered;
initiate play of the hold-and-spin game by populating a first type of feature symbol in the first play area and a second type of feature symbol in the second play area, each of the populated feature symbols associated with an award value; and
control the display device to display one or more spins of the hold-and-spin game, wherein, when a feature symbol of the first type appears in the second play area, the first play area is populated with an additional feature symbol of the first type and the feature symbol of the first type in the second play area is converted to the second type.

11. The non-transitory computer-readable medium of claim 10, wherein, when the feature symbol of the first type appears in the second play area, the first play area is populated with the additional feature symbol of the first type in a corresponding symbol position as the feature symbol of the first type appearing in the second play area.

12. The non-transitory computer-readable medium of claim 11, wherein, when the corresponding symbol position is already populated with an existing feature symbol, the award value of the existing feature symbol is increased by the award value of the feature symbol of the first type appearing in the second play area.

13. The non-transitory computer-readable medium of claim 12, wherein the visual indication that the hold-and-spin feature game is triggered is a triggering number of bonus tokens collected.

14. The non-transitory computer-readable medium of claim 10, wherein the feature of the feature game mode comprises a second feature, the second feature being a pick bonus game.

15. A computer-implemented method for providing an electronic game on an electronic gaming device, the method comprising:
controlling a display device to display an electronic game that includes a base game mode and a feature game mode;
generating an output in response to a player input at a gaming device;
evaluating the output to determine an award value;
selecting, based on the award value, a presentation record of the electronic game from a plurality of presentation records stored in a memory, wherein the plurality of presentation records includes:
a first presentation record set including presentation records each including an outcome of the base game mode without a feature;
a second presentation record set including presentation records each including a feature of the base game mode; and
a third presentation record set including presentation records each including a feature of the feature game mode;
wherein the first presentation record set is associated with a first range of award values, the second presentation record set is associated with a second range of award values different from the first range, and the third presentation record set is associated with a third range of award values different from the first range and the second range; and
controlling the display device to display the selected presentation record.

16. The method of claim 15, wherein the output is a bingo game outcome.

17. The method of claim 15, wherein the feature of the feature game mode comprises a first feature, the first feature being a hold-and-spin game that includes first and second play areas, wherein the method further comprises:
controlling the display device to display a visual indication that the hold-and-spin feature game is triggered;
initiating play of the hold-and-spin game by populating a first type of feature symbol in the first play area and a second type of feature symbol in the second play area, each of the populated feature symbols associated with an award value; and
controlling the display device to display one or more spins of the hold-and-spin game, wherein, when a feature symbol of the first type appears in the second play area, the first play area is populated with an additional feature symbol of the first type and the feature symbol of the first type in the second play area is converted to the second type.

18. The method of claim 17, wherein, when the feature symbol of the first type appears in the second play area, the first play area is populated with the additional feature symbol of the first type in a corresponding symbol position as the feature symbol of the first type appearing in the second play area.

19. The method of claim 18, wherein, when the corresponding symbol position is already populated with an existing feature symbol, the award value of the existing feature symbol is increased by the award value of the feature symbol of the first type appearing in the second play area.

20. The method of claim 19, wherein the visual indication that the hold-and-spin feature game is triggered is a triggering number of bonus tokens collected.
